(19) United States
(12) Patent Application Publication
(10) Pub. No.: US 2001/0022253 A1
(43) Pub. Date: Sep. 20, 2001

(54) ELEVATOR, PARTICULARLY A TRACTION SHEAVE ELEVATOR

(76) Inventors: GUNTER REUTER, FILDERSTADT (DE); HANS FERDINAND FRHR. V. SCHOLLEY, WOLFSCHLUGEN (DE); EBERHARD VOGLER, LEINFELDEN-ECHTERDINGEN (DE); HANS UNTERGASSER, NEUHAUSEN A.D.F. (DE)

Correspondence Address: SHLESINGER ARKWRIGHT & GARVEY, 3000 SOUTH EADS STREET, ARLINGTON, VA, 22202

(21) Appl. No.: 09/181,332

(22) Filed: Oct. 28, 1998

(30) Foreign Application Priority Data
Nov. 8, 1997 (EP) 97119575.5

(51) Int. Cl. B66B 9/02; B66B 1/26

(52) U.S. Cl. 187/254; 187/300; 187/414

(57) ABSTRACT

An elevator, particularly a friction driven elevator, with a cage guided in an elevator shaft and with a driving motor with associated control cabinet. According to the invention, in case of need and to provide access to the driving motor and/or control cabinet, a closed power unit space is provided which can be temporarily set up in the elevator shaft, whereby the operation of the cage in both portions of the elevator shaft which are situated below or above the temporarily set up power unit space remains unaffected. In the region of the power unit disposed in the shaft, the control cabinet is disposed in the shaft alongside the path on which the cage travels and there is provided at least one plate which, in order to form a negotiable platform and/or a protective roof, can be moved into a horizontal position associated with the control cabinet. Advantageously, in normal operation of the elevator, the plate serves as a cover for the control cabinet and is rotatably articulated on the control cabinet.

### FIELD OF THE INVENTION

The present invention refers to an elevator, particularly a traction sheave elevator, having a cage guided in an elevator shaft and having a driving motor with associated control cabinet.

### BACKGROUND OF THE INVENTION

In the past, in the case of elevator installations, by virtue of the regulations applicable to power units and associated switching means, separate occludable spaces (power unit spaces) were provided. In the planning of buildings, an aim was to achieve greater independence of the planning precepts of the elevator manufacturer and in order to save on the costs connected with providing a separate power unit space, recent years have seen elevators proposed which have no separate power unit space. Such elevators are known for example from EP 0 631 968 B1, EP 0 710 618 A2 and EP 0 719 924 A1. Where the elevators described in the citations are concerned, the driving motor unit is disposed completely in the elevator shaft so that no additional engine or propulsion unit space is required.

Usually, where such elevators are concerned, the driving motor is disposed in the upper or lower part of the elevator shaft between the area required by the cage when it is travelling and a wall of the elevator shaft. The control unit for the elevator is accordingly disposed in the door frame of the shaft door of the topmost or very bottom floor of the building and can be operated from the corridor of that floor for servicing and repair work. Operating the controls from the corridor of that floor means that during maintenance the corridor has to a certain extent to be shut off, which in an extreme circumstance means that escape routes are obstructed. Also, the maintenance or repair works are only possible to a limited degree since when the control elements are operated from the corridor there is no or only restricted visual contact with the cage and thus no (sufficient) observation of its behavior is possible. Checking the propulsion unit in operation at rated speed is therefore impossible.

In the case of an elevator with the power unit space disposed above the elevator shaft, it is known from EP 0 646 537 A1 to provide in the shaft head a plate or a carrier which can be disposed crosswise in the region of the shaft head and serve as a servicing platform.

Known from EP 0 725 033 A1 is a temporary working space safety arrangement by means of which penetration by the cage of a temporary working space such as for example the bottom of the shaft of an elevator can be avoided. For this purpose, pivoting buffers are provided which can be pivoted into the travelling area of the cage before the shaft pit is entered. The pivoting buffer is preferably tiltable by gravity automatically into the safety position in which it restricts the travel of the cage.

EP 0 129 678 A1 discloses an automatic means of safeguarding a temporary working space in the shaft pit and which comprises a lever which, as a means of limiting travel, can be pivoted mechanically into the path of the cage. When a door leading into the shaft is opened, the lever is positively pivoted into its safety position in which it restricts the travel of the cage, operation of the elevator being interrupted while the lever is pivoted into position.

### OBJECTS AND SUMMARY OF THE INVENTION

On this premise, the invention is based on the problem of providing an elevator of the above-mentioned type but which requires no separate power unit space and which nevertheless meets the requirements imposed on a power unit space.

In order to resolve this problem, an elevator according to the present invention is proposed. The elevator in accordance with the invention offers the opportunity of temporarily setting up a closed power unit space without the operation of the cage being adversely affected in those portions of the elevator shaft which are situated below or above the temporarily set up cage. Consequently, the availability of the elevator for public travel is improved in comparison with the prior art elevators which have no power unit space. Furthermore, repair and servicing work is no longer linked with any hindrance in the corridor since the servicing personnel can work in the power unit space temporarily set up in the elevator shaft and are able to carry out all the work from inside the shaft. The fact that the power unit space can be closed off is achieved particularly in that the temporary power unit space which can be entered through the shaft door, particularly of the topmost story of the building, can, once it has been entered by the servicing personnel, be closed by closing the shaft door. Whereas in the case of prior art elevators which have no power unit space, most repair work has to be carried out with the shaft door open, it is possible in the case of the elevator according to the invention for all servicing and repair work, with the exception of work on the doors, can be carried out with the shaft door closed, so minimizing the risk of injury to a third person (risk of falling). Since operation of the elevator in the other portions of the elevator shaft is not restricted, the servicing personnel working in the temporarily set up power unit space are able to observe the propulsion mechanism and switching arrangements directly during operation of the elevator at rated speed, so that adjustment work and fault tracing are substantially facilitated.

In practice, for setting up the temporary power unit space, the ideal location is the area of the shaft head (topmost stopping point in the elevator shaft) or the area of the shaft pit (the lowest stepping station in the elevator shaft). In particular, setting up the power unit space in the area of the shaft head is found to be advantageous because according to the invention operation of the elevator can be maintained on all floors below the topmost floor even while the servicing work is taking place.

In an advantageous further development of the invention, the control pattern of the cage when the power unit space is set up can be so selectively switched that the portion of the elevator shaft which is occupied by the temporarily set up power unit space can no longer be approached by the cage. According to the invention, therefore at least one control pattern for the cage for normal operation and also at least one control pattern for servicing work are provided, so ensuring that the cage does not travel into that portion of the elevator shaft which is occupied by the power unit space.

In a further advantageous development of the invention, a device for limiting the travel of the cage or the counterweight when the power unit space is set up is provided in order to avoid a collision between the cage and the power unit space. In this respect, it is found to be particularly advantageous for activation of the device for limiting travel to take place in a positive manner when the power unit space is being set up. According to the invention, therefore, there is a mechanical travel limitation of the cage directly or indirectly via the counterweight so that even in the event of a malfunction of the electronic control arrangement, a collision between the cage and the temporary power unit space is avoided.

In an advantageous further development of the invention, the device for limiting travel comprises a cross-member articulated on at least one guide rail of the cage or of the counter-weight. The carrier is preferably so articulated that in normal operation of the elevator it is held substantially vertically on the guide rail and when the temporary power unit space is set up, it is pivoted automatically under the action of gravity into a safety position which limits the travel of the cage or of the counterweight as the case may be. Preferably, the cross-member is disposed in such a way as to limit the downwards travel of the cage when the control cabinet and the temporarily set up power unit space are disposed in the shaft pit or in the region of the very lowest stopping station in the elevator shaft and correspondingly, to limit the travel of the counterweight downwards when the control cabinet and the temporarily set up power unit space are disposed in the shaft head of the elevator shaft or in the region of the topmost stopping station. In a particularly advantageous further development, the upwardly pointing buffer usually disposed in the shaft pit and intended for the counterweight or the cage is mounted (to point downwards) on the cage or on the counterweight so that no additional buffer has to be mounted on the cross-member.

Advantageously, the bottom and/or the top of the power unit space consist of at least one plate which is to be disposed crosswise in the shaft and which in a further advantageous development, can be disposed at different heights. Thus, according to the repair or servicing activity occurring the temporary power unit space can be positioned at different heights in the elevator shaft. In a further development of the invention, the plate comprises areas of different heights so that access to and departure from the temporary space is made possible to facilitate the repair activity.

In a particularly advantageous development, the plate is permanently disposed in the elevator shaft so that setting up the temporary power unit space is rendered particularly easy.

For further solution of the problem on which the invention is based, an elevator is proposed which has the control cabinet is disposed in the elevator shaft alongside the track on which the cage runs and at least one plate is provided which can be brought into a horizontal position in relation to the control cabinet to form a negotiable platform and/or protective roof. This development on the one hand permits a space-saving disposition of the control cabinet in the elevator shaft which exploits fully the cross-section of shaft which is available and on the other it provides particularly simple access to the control cabinet for servicing and repair work.

In a particularly advantageous further development of the invention it is envisaged for the at least one plate to serve as a cover for the control cabinet in ordinary use of the elevator. Thus, in accordance with the invention, the plate which is in any case present as a covering for the control cabinet fulfills a dual role in that, during servicing or repair work on the elevator, the plate can be moved into a horizontal position to form a negotiable platform and/or a protective roof. Preferably, the at least one plate is articulated at the bottom and/or top of the control cabinet so that by simple pivoting the plate can be brought into the desired horizontal position. Advantageously, when it is in the horizontal position, the plate has at least its end opposite the articulation resting on a support.

In a development of the invention, the plate is so articulated that it moves into the desired horizontal position under its own weight.

In a further development of the invention, a safety arrangement is provided which is associated with the horizontal position of the plate, for prevention of people falling, the safety arrangement being in particular a hand rail. As a result of this measure, the plate, together with the associated safety arrangement and the, as previously already explained, occludable shaft door, form a closed temporary power unit space. In this respect, instead of comprising simple cross struts, the safety arrangement can comprise in accordance with a development of the invention, at least two struts articulated on the plate and the control cabinet in the form of a parallelepiped and which form a safety hand rail when the plate has been pivoted into the horizontal position.

In a particularly advantageous development of the invention, the plate can be moved between its normal position and horizontal position by means of a motor operated drive which can be actuated from outside the elevator shaft. As a result of this measure, it is guaranteed that the shaft door has to be opened only in order to walk onto the plate which has been moved into the horizontal position. Movement of the plate into the horizontal position takes place when the shaft door is closed and from outside the elevator shaft, in particular from an arrangement in or adjacent to the door casing of the associated shaft door and accessible from the corridor on the floor of the building. Once the servicing personnel have passed on to the plate which serves as a platform, the shaft door is closed again and the necessary servicing and repair work can take place with the shaft door closed. Consequently, in accordance with the invention, the danger of third parties falling is minimized.

In a further development of the invention, means are provided for electrically monitoring one or both extreme positions of the plate, said means communicating with means of limiting the travel of the cage or of the counterweight when the plate is in the horizontal position. This ensures that when the plate is in the horizontal position, the cage cannot collide with the plate. As a travel limiting means, the already aforedescribed device which advantageously comprises a cross-member articulated on at least one guide rail of the cage or of the counterweight is preferably suitable.

For further solution of the problem on which the invention is based, a device is proposed for temporarily limiting the travel of a cage or counterweight. By virtue of the disposition of the bracing element of the device for limiting travel, in accordance with the invention, in the operative position in a horizontal supported position parallel with a plane through the two guide rails of the cage or counterweight, in the event of the cage or the counterweight striking the braking element, no moments and thus no spreading forces are created. The forces exerted on the bracing element as a result of the impact of the cage or counterweight are dissipated mainly in the direction of impact, i.e. at right-angles to the bracing element, via the supports which are provided to support the bracing element.

In a further development of the invention, the bracing element comprises two profile sections disposed parallel with each other and which engage around the guide rails. Consequently, in the operative position, the bracing element has two profile sections engaging around the guide rails so that a symmetrical arrangement results. As a result of this symmetrical arrangement, there is a symmetrical dissipation of the forces in the event of an impact by the cage or counterweight so that a unilateral loading on the fixing means and anchorings of the individual elements of the travel limiting device is avoided.

In a further development of the invention, an impact plate is provided, rotatably articulated on one of the profile sections. In the horizontal and operative position, this rests on both profile sections and serves as an impact area for a buffer mounted on the cage or counterweight. By virtue of the impact plate according to the invention, the intermediate space present between the two profile sections is bridged and the pulse transmitted in the event of impact is dissipated via the impact plate to the profile sections of the bracing element and farther on to the supports which carry the bracing element. Advantageously, the impact plate is so articulated on the bracing element that when this latter is in its operative position, it moves under its own weight into the desired position of resting on the two profile sections.

The bracing element according to the invention can block travel on one side of the guide rail plane or, if it is divided, then it can do so on both sides or it may block travel also diagonally, e.g. from the right-hand side of the first rail to the left-hand side of the second rail. In this case, the buffer impact area, even without an additional impact plate, can likewise be disposed in the plane of the guide rails and only the cross-member pivot point and the second support are respectively disposed on one side of the rail.

In a further development of the invention, the pivot mounting of the bracing element is force-free in the horizontal supported operative position of the bracing element. This avoids a situation where, in the case of an impact of the cage or counterweight on the bracing element, forces are conveyed into the pivot mounting. Advantageously, the pivot mounting is an elongated hole mount. In the inoperative position of the bracing element outside the travel of the cage or counterweight, i.e. in an essentially vertical position, the corresponding bearing journals of the bracing element rest in the substantially vertically extending elongated holes. In the horizontal operative position of the bracing element, this latter is so supported on the pivot bearing side that the bearing journals are not in their extreme position within the elongated holes.

In a further development of the invention, in order to support the bracing element in the operative position, rests are disposed on the guide rails. By disposing the rests on the guide rails, a particularly advantageous dissipation of forces occurring in the event of an impact on the bracing element is achieved along the guide rails which are for example anchored in the wall of the elevator shaft.

In a further development of the invention, the bracing element is disposed on the first guide rail and advantageously it is rotatably mounted in a head piece fixed on the first guide rail.

In summary, the present invention is directed to an elevator, in particular a traction sheave elevator, with a cage guided in a elevator shaft and with a driving motor with an associated control cabinet, characterized by a closed power unit space which can, if necessary, be set up temporarily in the elevator shaft to provide access to the driving motor and/or the control cabinet, the normal operation of the cage in those portions of the elevator shaft which are situated below or above the temporarily arranged power unit space remaining unaffected. The power unit space can be set up in the area of the shaft head and in a topmost stopping point or in the region of the shaft pit and a very lowest stopping point within the elevator shaft. The pattern of control of the cage when the power unit space is set up can be so selectively switched that the portion of elevator shaft which is occupied by the power unit space can no longer be approached by the cage. A device for limiting the travel of the cage or of the counterweight is provided in order to prevent the cage colliding with the power unit space when this latter is set up. Activation of the device for limiting travel takes place in a positive manner when the power unit space is set up. The elevator according to the present invention is also characterized in that the bottom and/or the top of the power unit space consist of at least one plate which is to be disposed crosswise in the shaft, the plate comprises areas of different heights and is disposed permanently in the elevator shaft.

An elevator, particularly a traction sheave elevator according to the present invention includes a cage guided in an elevator shaft and a driving motor with associated control cabinet, characterized in that the control cabinet is disposed in the elevator shaft beside the track on which the cage travels and in that at least one plate is provided which is adapted for movement into a horizontal position associated with the control cabinet to form a negotiable platform and/or a protective roof. At least one plate is disposed in the elevator shaft above, below or opposite the control cabinet, and the at least one plate is pivotable. During normal operation of the elevator, the at least one plate serves as a cover for the control cabinet and is rotatably articulated at the bottom and/or top of the control cabinet. In the horizontal position, the plate has at least the end of articulation resting on a support. The plate is so articulated that it moves into the horizontal position under its own weight. A safety device associated with the horizontal position of the plate is provided to prevent persons from falling. The plate can be moved between its normal position and the horizontal position by means of a motorized drive actuated from outside the elevator shaft. Means are provided for electrical monitoring of one or both extreme positions of the plate. The electric monitoring means communicate which a device for limiting the travel of the cage or of the counterweight when the plate is in the horizontal position.

The present invention is also directed to a device for temporarily limiting the travel of a cage or of a counterweight for an elevator having a bracing element which, in its position of rest, is disposed outside the path followed by the cage or counterweight, in the region of a first guide rail of the cage or counterweight and which is adapted to be pivoted into an operative position in which it projects into the path of travel, characterized in that pivoting of the bracing element takes place parallel with or diagonally through a plane given by the first guide rail and a second guide rail which is opposite the first guide rail and in that, in its operative position, the bracing element occupies a substantially horizontal supported position. The bracing element comprises two profile members which are disposed parallel with each other and which, in the operative position, engage around the guide rails. Rotatably articulated on one of the profile sections, an impact plate is provided which, in the horizontal and operative position, rests on both profile sections and serves as an impact surface for a buffer mounted on the cage or counterweight. The pivot mounting of the bracing element is substantially force free in the horizontal supported and operative position of the bracing element. The pivot mounting is an elongated hole mount for supporting the bracing element in the operative position, rests are provided which are disposed on the guide rails. The bracing element is disposed on a first guide rail. The bracing element is rotatably mounted in a head piece mounted on the first guide rail.

### BRIEF DESCRIPTION OF THE DRAWINGS

The invention is described in greater detail hereinafter with reference to embodiments which are diagrammatically shown in the accompanying drawings, in which:

FIG. 1 shows a cross-section through the topmost story of an elevator system according to the invention with the cage at the topmost story and during normal operation;

FIG. 2 shows a cross-section through FIG. 1 during maintenance work with a temporarily set up power unit space and a cage situated beneath the power unit space;

FIG. 3 shows a view of the elevator according to the invention taken on the line III-III in FIG. 2;

FIG. 4 is a perspective view of the detail in FIG. 3, and

FIG. 5 shows a device according to the invention for temporarily limiting the travel of a counterweight.

### DETAILED DESCRIPTION OF THE PREFERRED EMBODIMENTS

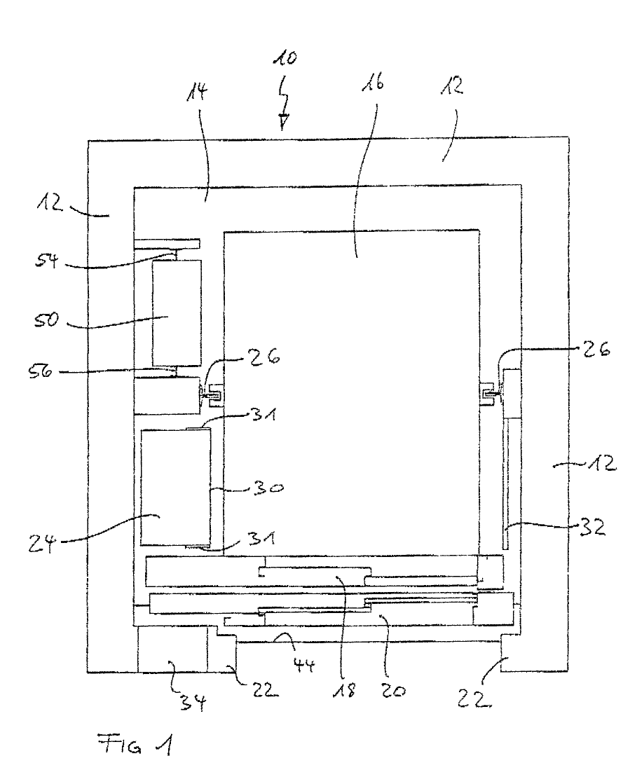

FIG. 1 shows a cross-section through the topmost deck of an elevator 10 according to the invention. The elevator 10 comprises, limited by shaft walls 12, an elevator shaft 14 in which a cage 16 is guided to travel vertically along guide rails 26. On the deck side, there is in the shaft wall 12 and bounded by a door frame 22, a door aperture which is closed by a shaft door 20. Associated with the cage 16 is a cage door 18 which can be opened jointly with the shaft door 20 in order to open the through way between cage 16 and deck.

Between the cage 16 and the shaft wall 12 which is shown on the left in FIG. 1 there are on the shaft wall 12 a counterweight 50 guided in rails 54, 56 and a control cabinet 24. The control cabinet 24 has on the shaft side a plate 30 as an openable covering. Associated with the control cabinet 24 is a driving motor for the elevator 10 which is not shown in greater detail and which is likewise disposed in the shaft. Advantageously, the control cabinet is disposed in the area of the driving motor.

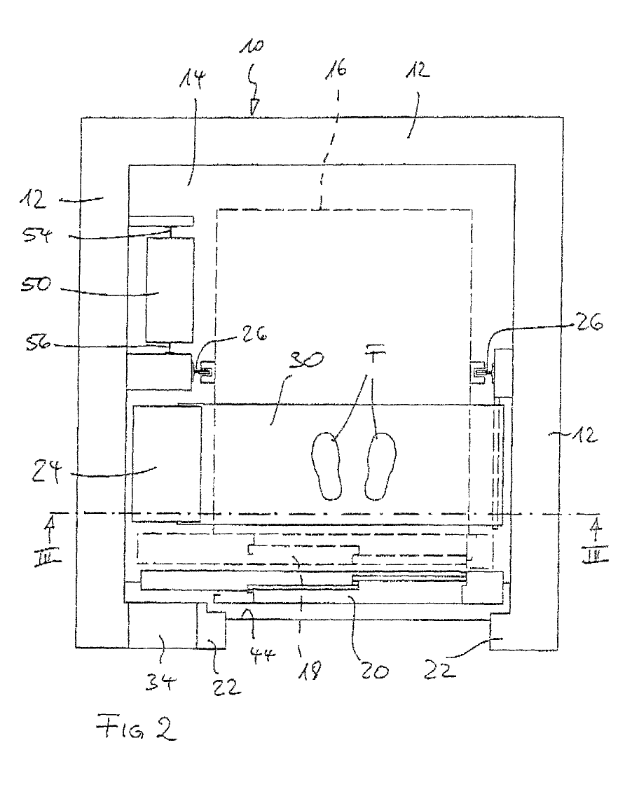

FIG. 1 shows the elevator 10 according to the invention in normal operation with the cage 16 stopped at the topmost stopping point. For carrying out work for which the control cabinet 24 must be accessible (servicing work), the cage 16 is moved downwards out of the topmost station. The maintenance work in FIG. 2 is only shown by broken lines indicating the cage 16 and the cage door 18.

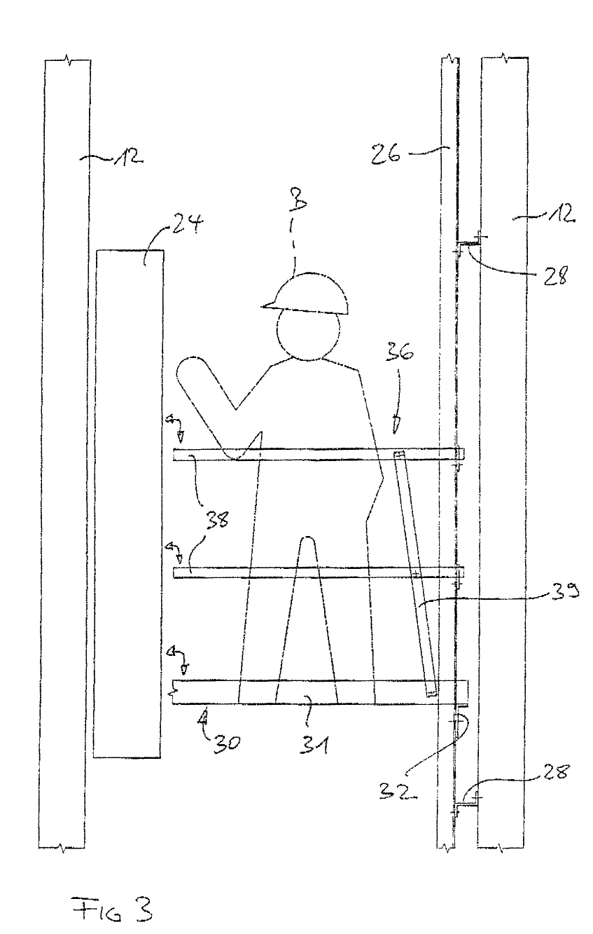

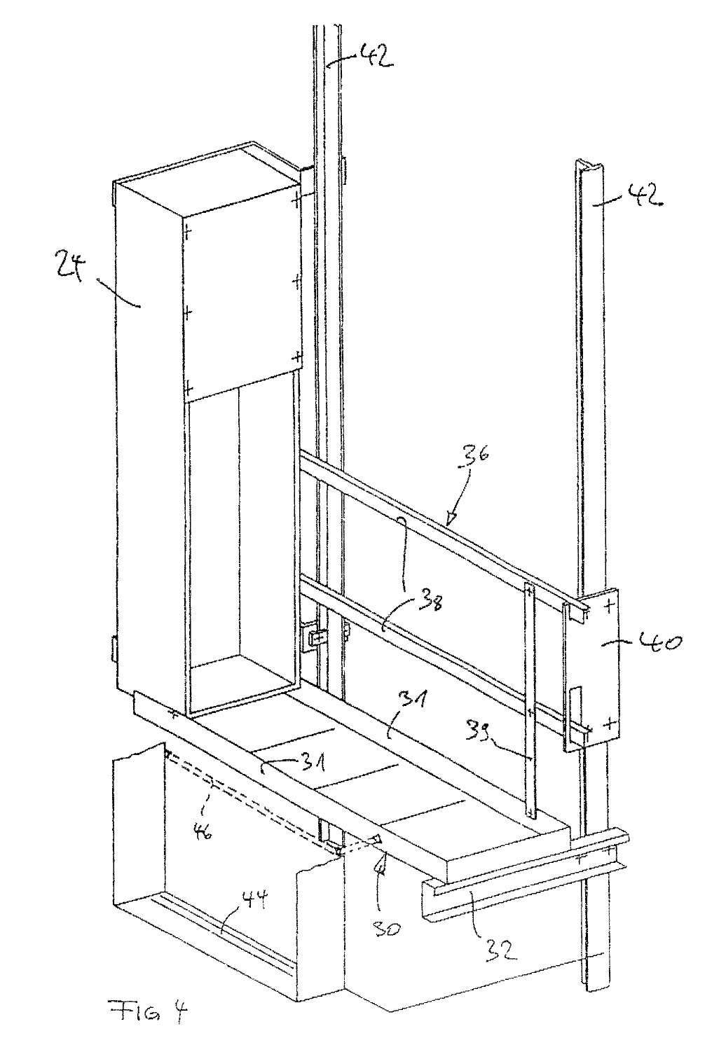

In order to initiate servicing of the elevator 10, the plate 30 which serves as a cover of the control cabinet 24 is lowered via an operating box 34 which is disposed to the left of the door casing 22 as shown in FIGS. 1 and 2. The plate 30 is rotatably articulated in the bottom area of the control cabinet 24 (see FIGS. 3 and 4) and is moved upwards and downwards, for example by means of a cable arrangement, not shown in detail. In order to simplify the process of lowering or swinging out the plate 30 into the desired horizontal position, the plate 30 is so articulated on the control cabinet 24 that under force of gravity it is pulled into the horizontal under its own weight. The cable is operated advantageously by electricity and in the event of a power failure, it can be supplied by a 12 V battery. The cable drum of the cable drive is advantageously disposed on or in the control cabinet 24 in the upper part of the vertical plate 30 and the cable engages the top end of the vertical plate 30.

Upon reaching the desired horizontal position, the plate 30 has its end opposite the articulation on the control cabinet 24 resting on a support 32 provided on a guide rail 26 of the cage 16 and it forms a platform on which anyone can walk. This is indicated in the view in FIG. 2 by means of footprints F and in the view in FIG. 3 by means of the dash-dotted operator B. The guide rail 26 is fixed on the shaft wall 12 by means of brackets 28.

In order to enhance the stability of the plate 30, this has at least along its long sides a raised rim 31 which additionally serves as a plinth strip and safeguard against crawling. Furthermore, for reasons of safety, a hand rail 36 is provided which consists of two longitudinal struts 38 articulated laterally on the control cabinet 24 and a cross strut 39 which articulatingly connects the two longitudinal struts 38 to the plate 30. The hand rail struts 38, 39 can be pivoted jointly with the plate 30 in the manner of a parallelepiped. To enhance stability, when a horizontal orientation is reached, the longitudinal struts 38 engage a support 40 provided on the guide rail 26.

After the plate 30 has been lowered into the horizontal position in which it serves as a walk-on platform, the shaft door 20 is open so that the platform can be entered by the servicing person. The gap present between a deck step 44 and the plate 40 (see FIG. 4) corresponds in its height and depth to the gap dimensions allowed within the regulations. If necessary, it is possible to provide on the plate 30 as a bottom safeguard an additional strut 46 (shown in broken lines) 46 to reduce the gap and possibly serve as an aid to entering.

Once the platform has been entered, the operator B is able to close the shaft door 20 again behind him. Consequently, according to the invention, the lowered plate 30 which forms the negotiable platform, the safety hand rail which is connected to the plate 30, the shaft walls 12 and the shaft door 20 form a temporarily set up and enclosed power unit space in which the servicing personnel can carry out any work necessary while screened from the public. In particular, no shut off measures are needed which might adversely affect public traffic or in an extreme case interfere with the escape routes. Where the public is concerned, the servicing work is revealed in that the cage 16 is no longer capable of travelling to the top floor since this part of the elevator shaft is occupied by the temporary power unit space. On all floors situated below the temporary power unit space, however, regular operation of the elevator is possible. The necessary safety arrangements such as limit switches are correspondingly also provided for the temporary power unit space. Furthermore, in addition to the components for the temporary power unit space the shaft cross-section also contains the safety space needed above and below.

For the operating or servicing personnel, the temporarily set up power unit space according to the invention affords the further advantage that the cage 16 and other components in the shaft such as for example the driving motor, the speed limiters and the like, can be observed from the platform so that any necessary adjustments can be carried out while the elevator is in operating mode and at rated speeds.

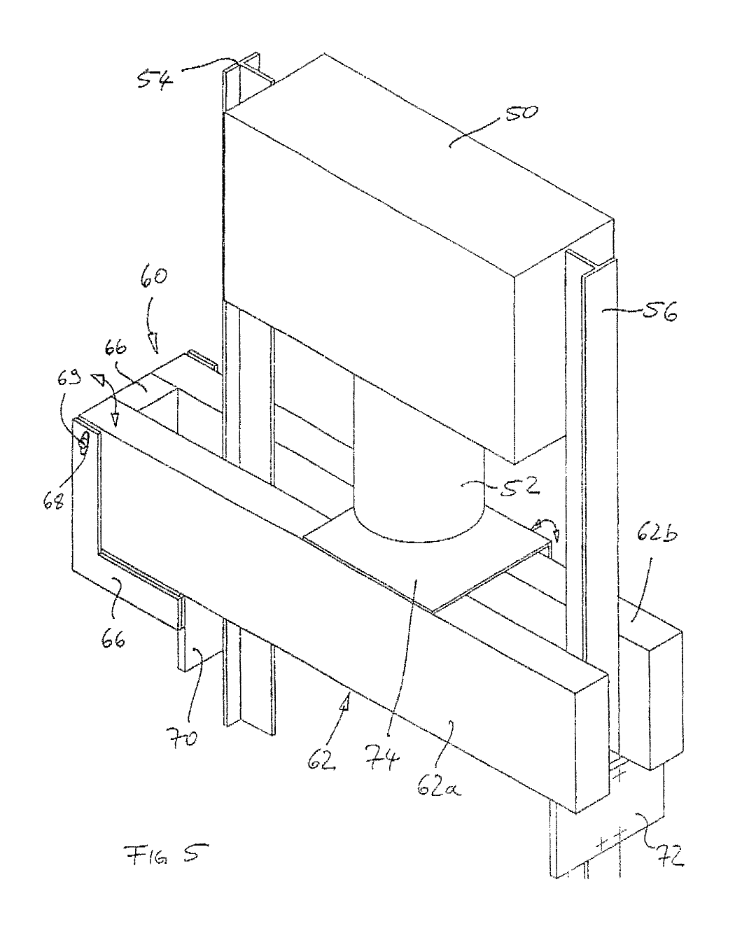

To safeguard the lowed plate 30 against a collision with the cage 16, the invention provides for a device for temporarily limiting the travel of the counterweight 50 down-wards (see FIG. 5). The travel limiting device according to the invention (travel limiter) 60 comprises a bracing element 62 disposed in the bottom area of the shaft at a suitable height and on a first guide rail 54 of the counterweight 50, the said bracing element 62 being of metal in particular. The bracing element 62 comprises two elongated profile sections 62a, 62b which are parallel with and spaced apart from each other in their mountings at one head end in a head piece 66, being mounted on the head end by means of bearing journals 69 so that they can rotate in the head piece 66. To accommodate the bearing journals 69, there are in the head piece 66 elongated holes 68 which extend in a substantially vertical direction. In the example of embodiment illustrated, the head piece 66 is disposed on the first guide rail 54. The bracing element 62 is so articulated in the head piece 66 that its profile sections 62a, 62b engage around the guide rail 54 and it is drawn by its own weight into a horizontal position (operative position) in which it restricts the travel of the counterweight 50.

During normal operation of the elevator, the bracing element 62 is maintained in a substantially vertical positive position on the first guide rail 54 outside the path of travel of the counterweight 50. This is achieved for example by means of switchable magnets. Ideally, electrical monitoring of the two extreme positions (positive position and operative position) of the bracing element 62 is provided. When the plate 30 is lowered by the appropriate actuation of an element in the control box 34, this positive position of the bracing element 62 is released. This is achieved for example by means of a sensor switch which monitors the position of the plate 30 at the control box 24. Thereupon, by force of gravity, the bracing element 62 falls into a horizontal position in which those ends of the profile sections 62a, 62b which are opposite the articulation rest on a support provided on the second guide rail 56 of the counterweight 50.

Furthermore, in the operative position of the travel limiter 60, the profile sections 62a, 62b rest on a support 70 disposed on the first guide rail 54 and which, in the case of the embodiment shown in FIG. 5, also serves to secure the head piece 66. By supporting the bracing element 62 on the rest 70, the bearing journals 69 are so raised in the elongated holes 68 described that they are no longer a burden on the elongated holes 68, so that the pivot mounting of the bracing element is free from any forces in the operative position. The rests or supports 70, 72 are advantageously screwed to the guide rails 54, 56 in the region of a rail joint, the four holes in any case provided for the fishplates of the guide rails being used for the purpose. Preferably, in addition to functioning as rests, the rests or supports 70, 72 additionally fulfil the role of fishplates.

In the horizontal operative position shown in FIG. 5, the travel limiter 60 with the bracing element 62 restricts the travel of the counterweight 50, there being provided on the counterweight 50 a buffer 52 which strikes an impact plate 74 on the bracing element 62. The impact plate 74 rests on the two profile sections 62a, 62b and is so rotatably articulated on the profile member 62b (in a manner which cannot be seen in FIG. 5) that it can be pivoted away to expose the intermediate space between the profile sections 62a, 62b when the bracing element 62 is being raised up to the first guide rail 54. In the pivoted-away condition, the impact plate 74 forms with the bracing element 62 advantageously an angle which is less than 90° the effect of this being that the centre of gravity of the impact plate lies in front of the pivot axis and, with a horizontal pivot axis, the impact plate drops down under its own weight and rests on the profile sections 62a, 62b.

With the travel limiter according to the invention and which is illustrated in the drawings, there is a substantially moment-free dissipation of the forces exerted on the travel limiter upon an impact of the counterweight, the forces being dispersed via the rests provided on the guide rails, along the guide rails and the rail brackets which serve to secure the guide rails. Since effective forces only occur in the direction of the guide rails, the travel limiter according to the invention entails less strain on the fixing means in the shaft, particularly rail brackets, so that a lesser number of rail brackets need to be used or the rail brackets used can be of smaller size. The travel limiter according to the invention is particularly suitable for use with the temporary power unit space according to the invention since the travel limiter reliably avoids a collision between the cage and the platform of the temporary power unit space so that running of the elevator below or above the temporary power unit space is guaranteed.

The bracing element of the travel limiter according to the invention can naturally also comprise a profile section which in the operative position comes to rest alongside the guide rails of the counterweight (or cage). The embodiment shown in FIG. 5 which has two parallel profile sections which in their operative position engage around the guide rails does however guarantee a symmetrical dissipation of any forces which arise so that the guide rails which serves to disperse such forces do not suffer a unilateral loading and distortion of the guide rails is out of the question. The profile sections can be of both one piece or also multi-part construction and by reason of their construction and design they can satisfy the requirements in terms of sufficient stability and torsional rigidity.

The invention is not limited to those examples of embodiment which are shown in the drawings and which are described in the description of the figures. For example, it is possible to dispose the control cabinet in the shaft pit and/or in the region of the bottom story and for travel limitation to be provided above the bottom-most floor and not in the path of travel of the counterweight but in the path of travel of the cage. In the event of the control cabinet being disposed in the bottom-most floor, it is indicated to construct the plate as an upwardly pivotable plate so that it forms the protective roof of the temporarily set up power unit space. Also in the embodiment of the invention which has been described, with the control cabinet disposed in the topmost floor, an additional plate can be provided which is upwardly pivotable and which functions as a protective roof (which can be walked on and which is provided with a safety grille) for the temporarily set up power unit space. For this purpose, the covering of the control cabinet may also be divided for instance half-way up the bottom part of the cover being adapted to be folded down to become a negotiable platform while the upper portion can be swung upwards to serve as a protective roof.

The negotiable platform for the power unit space which can be set up temporarily according to the invention does not need to be constituted by a pivotable covering of the control cabinet. For example, the plate can be attached to the cover of the elevator shaft head outside the path of travel of the cage and if need be it can be let down by means of a table or the like in which case various heights can be chosen for the platform. The safeguard against people falling can in this case be constructed as a protective grille which can be rolled up. The plate for the platform on which people can walk may for example be disposed not on the control cabinet but on the shaft wall alongside the rails or opposite the control cabinet or even behind the door frame, in a recess in the shaft door or on a shaft wall, from which location it can even be removed manually and placed at some appropriate spot in the elevator shaft.

In order to achieve the most flexibly usable elevator possible, it is advantageous for individual control functions to be removed from the elevator shaft and integrated for example into the operating cabinet accessible from the corridor of the building, such control functions being particularly the freeing of persons, diagnostic procedures, technical monitoring and testing and the like.

The invention is not confined in its application to elevators in which the driving motor with the cable drive is disposed in the elevator shaft above or below the area required by the cage. Instead, it is also suitable for a disposition of the driving motor in the elevator shaft beside the space required for the cage travel.

We claim:

1. An elevator, in particular a traction sheave elevator comprising a cage guided in an elevator shaft, a driving motor having an operatively associated control cabinet, a closed power unit space adapted to be selectively set up in the elevator shaft for providing access to at least one of said driving motor and said control cabinet, the normal operation of said cage in those portions of the elevator shaft which are situated below or above said power unit space when set up remaining unaffected.

2. An elevator according to claim 1, and wherein said power unit space can be selectively set up in the area of at least one of the shaft head and in a topmost stopping point or in the region of the shaft pit and a very lowest stopping point within the elevator shaft.

3. An elevator according to claim 1, and wherein the pattern of control of said cage when said power unit space is set up can be so selectively switched that the portion of the elevator shaft that is occupied by said power unit space can no longer be approached by said cage.

4. An elevator according to claim 1, and further including a device for limiting the travel of one of said cage or of a counterweight in order to prevent said cage from colliding with said power unit space when the latter is set up.

5. An elevator, particularly a traction sheave elevator, as in claim 1 wherein said cage is guided in the elevator shaft by said driving motor operatively associated with said control cabinet, said control cabinet is disposed in the elevator shaft beside a track on which said cage travels, at least one plate is provided which is adapted for movement into a horizontal position associated with said control cabinet to form at least one of a negotiable platform or a protective roof.

6. An elevator according to claim 5, and wherein during normal operation of said elevator, said at least one plate functions as a cover for said control cabinet.

7. An elevator according to claim 5, and further including a safety device associated with said plate in the latter's horizontal position to prevent persons from falling.

8. An elevator according to claim 5, and further including means for electrical monitoring at least one of the extreme positions of said plate, said means connected to a device for limiting the travel to one of said cage or said counterweight when said plate is in a horizontal position.

9. A device for temporarily limiting the travel of a cage or of a counterweight for an elevator as in claim 1, including a bracing element which, in its position of rest, is disposed outside the path followed by said cage or said counterweight, in the region of one of a first guide rail of said cage or said counterweight and which is adapted to be pivoted into an operative position in which it projects into the path of travel, whereby pivoting of said bracing element takes place parallel with or diagonally through a plane given by said first guide rail and a second guide rail which is opposite to said first guide rail so that in its operative position, said bracing element occupies a substantially horizontal supported position.

10. A device according to claim 9, and wherein said bracing element comprises at least two profile sections that are disposed parallel to each other and which, in an operative position, engage around said guide rails.

11. A device according to claim 10, and further including an impact plate rotatably articulated on one of said profile sections which, in the horizontal and operative position, rests on both of said profile sections and function as an impact surface for a buffer mounted on one of said cage or said counterweight.
